(19) United States
(12) Patent Application Publication
(10) Pub. No.: US 2026/0246387 A1
(43) Pub. Date: Aug. 20, 2026

(54) DC-DC CONVERTER WITH PARALLEL SWITCHES AND CONTROL METHOD THEREOF

(71) Applicant: ABLEREX ELECTRONICS CO., LTD., New Taipei City (TW)

(72) Inventors: WEN JUNG CHIANG, Kaohsiung (TW); CHIN CHANG WU, Kaohsiung (TW); YAO JEN CHANG, Kaohsiung (TW)

(21) Appl. No.: 19/072,200

(22) Filed: Mar. 6, 2025

(30) Foreign Application Priority Data
Feb. 19, 2025 (TW) 114106026

(51) Int. Cl. H02M 3/158; H02M 3/00

(52) U.S. Cl. CPC H02M 3/1586; H02M 3/01

(57) ABSTRACT

A DC-DC converter with parallel switches and control method thereof are disclosed. The DC-DC converter comprises a switching DC-DC conversion circuit and a control unit. The switching DC-DC conversion circuit comprises at least one switch unit comprising N switches connected in parallel. The N switches comprise an i^{th} switch and an (i+1)^{th} switch. N is a positive integer higher than or equal to 2, and i is a positive integer from 1 to N−1. The control unit is electrically connected to the N switches of the at least one switch unit to respectively turn on or off the N switches of the at least one switch unit. The control unit outputs an i^{th} driving signal and an (i+1)^{th} driving signal to the i^{th} switch and the (i+1)^{th} switch respectively. Conduction phases of the i^{th} driving signal and the (i+1)^{th} driving signal are alternate with each other.

### CROSS REFERENCE TO RELATED APPLICATIONS

This application claims the benefit under 35 U.S.C. § 119(a) to Patent Application No. 114106026 filed in Taiwan on Feb. 19, 2025, which is hereby expressly incorporated by reference into the present application.

### BACKGROUND OF THE INVENTION

### 1. Field of the Invention

The present application relates generally to a DC-DC converter, and more particularly to a DC-DC converter with parallel switches and a control method thereof.

### 2. Description of Related Art

Switching direct current to direct current (DC-DC) converter is a switch mode power supply (SMPS) comprising a switch, such as a transistor. Based on the switching operation for the switch, a DC input power will be converted to a required DC output power to implement the power conversion function. Based on a requirement to expand the output capacity of the switching DC-DC converter, the foregoing switch could be further electrically connected to at least one switch in parallel (i.e. the number of the switches is higher than or equal to 2).

For example, the non-isolated Boost converter 40 shown in FIG. 9 comprises two switches electrically connected in parallel. The two switches are defined as a first switch 401 and a second switch 402 respectively. The gate of the first switch 401 receives a first driving signal S1′ from a control unit, and the gate of the second switch 402 receives a second driving signal S2′ from the control unit. With reference to FIGS. 10A and 10B, the first driving signal S1′ and the second driving signal S2′ are pulse-width modulation (PWM) signals with the period T′, such that the frequency is 1/T′ (Hz). In general, the first driving signal S1′ and the second driving signal S2′ have the same conduction phase. Namely, the positions and the widths of the pulses P1′,P2′ of the first driving signal S1′ and the second driving signal S2′ are the same.

With reference to FIGS. 9 and 10A-10C, the non-isolated Boost converter 40 comprises an inductor L′. An inductor current IL′ flowing through the inductor L′ varies with the occurring positions of the pulses P1′,P2′ of the first driving signal S1′ and the second driving signal S2′. Hence, the operation frequency of the inductor L′ (i.e. the frequency of the inductor current IL′) is equal to the frequency of the first driving signal S1′ and the second driving signal S2′ (1/T′ Hz).

However, the first switch 401 and the second switch 402 have different properties to cause uneven current sharing, and the utilization of the first switch 401 and the second switch 402 would be decreased. Besides, for the purpose to expand the output capacity of the non-isolated Boost converter 40, the inductor L′ should be a high-order inductor with a bigger volume. As a result, overall volume and weight of a circuit product having the non-isolated Boost converter 40 will be increased, and the loss by the inductor L′ will affect the power conversion efficiency.

### SUMMARY OF THE INVENTION

An objective of the present invention is to provide a DC-DC converter with parallel switches and a control method thereof, to overcome the problems resulting from the expansion of the output capacity for the conventional converter as mentioned above and to improve circuit performance.

The DC-DC converter of the present invention comprises a switching DC-DC conversion circuit and a control unit. The switching DC-DC conversion circuit comprises at least one switch unit each comprising N switches connected in parallel. The N switches comprise an i^{th} switch and an (i+1)^{th} switch. N is a positive integer higher than or equal to 2, and i is a positive integer from 1 to N−1. The control unit is electrically connected to the N switches of the at least one switch unit to respectively turn on or off the N switches of the at least one switch unit. The control unit outputs an i^{th} driving signal and an (i+1)^{th} driving signal to the i^{th} switch and the (i+1)^{th} switch respectively. Conduction phases of the i^{th} driving signal and the (i+1)^{th} driving signal are alternate with each other.

The control method of the present invention is performed in a control unit. The control unit is electrically connected to at least one switch unit each comprising N switches connected in parallel. The N switches comprise an i^{th} switch and an (i+1)^{th} switch. N is a positive integer higher than or equal to 2, and i is a positive integer from 1 to N−1. The control method comprises steps as follows: outputting an i^{th} driving signal to the i^{th} switch; and outputting an (i+1)^{th} driving signal to the (i+1)^{th} switch, wherein conduction phases of the i^{th} driving signal and the (i+1)^{th} driving signal are alternate with each other.

According to the technical feature of the i^{th} driving signal and the (i+1)^{th} driving signal having alternate conduction phases of the present invention, for each of the at least one switch unit, the N switches are turned on alternately. As a result, the current alternately flows through the N switches to achieve an effect of automatic even current sharing, to improve the utilization of the N switches, and to equalize the heat of the N switches. In addition, the present invention can increase the operation frequency of a transformer of the switching DC-DC conversion circuit (as an isolated conversion circuit), or increase the operation frequency of an inductor of the switching DC-DC conversion circuit (as a non-isolated conversion circuit). Accordingly, the inductance of the transformer or the inductor would be decreased due to the increase of the foregoing operation frequency. Therefore, the volume and the weight of the transformer or the inductor could be further reduced. Correspondingly, the cost of the transformer or the inductor could be reduced. The loss by the transformer or the inductor could be reduced. The power conversion efficiency and the power density of the DC-DC converter of the present invention could be further improved due to the reduction of the loss by the transformer or the inductor.

### BRIEF DESCRIPTION OF THE DRAWINGS

FIG. 1 is a circuit diagram of an embodiment (non-isolated Boost converter) of the present invention;

FIG. 2 is a circuit diagram of an embodiment (non-isolated Boost converter) with two switches of the present invention;

FIG. 3A is a waveform diagram of a first driving signal outputted to a first switch of an embodiment of the present invention;

FIG. 3B is a waveform diagram of a second driving signal outputted to a second switch of an embodiment of the present invention;

FIG. 3C is a waveform diagram of the current flowing through the inductor of an embodiment of the present invention;

FIG. 4 is a circuit diagram of an embodiment (non-isolated Buck converter) of the present invention;

FIG. 5 is a circuit diagram of an embodiment (non-isolated Buck-Boost bidirectional converter) of the present invention;

FIG. 6 is a circuit diagram of an embodiment (isolated Flyback converter) of the present invention;

FIG. 7 is a circuit diagram of an embodiment (isolated Half-Bridge converter) of the present invention;

FIG. 8 is a circuit diagram of an embodiment (isolated Full-Bridge converter) of the present invention;

FIG. 9 is a circuit diagram of a conventional non-isolated Boost converter;

FIG. 10A is a waveform diagram of a first driving signal outputted to a first switch of the conventional non-isolated Boost converter;

FIG. 10B is a waveform diagram of a second driving signal outputted to a second switch of the conventional non-isolated Boost converter; and

FIG. 10C is a waveform diagram of the current flowing through the inductor of the conventional non-isolated Boost converter.

### DETAILED DESCRIPTION OF PREFERRED EMBODIMENT(S)

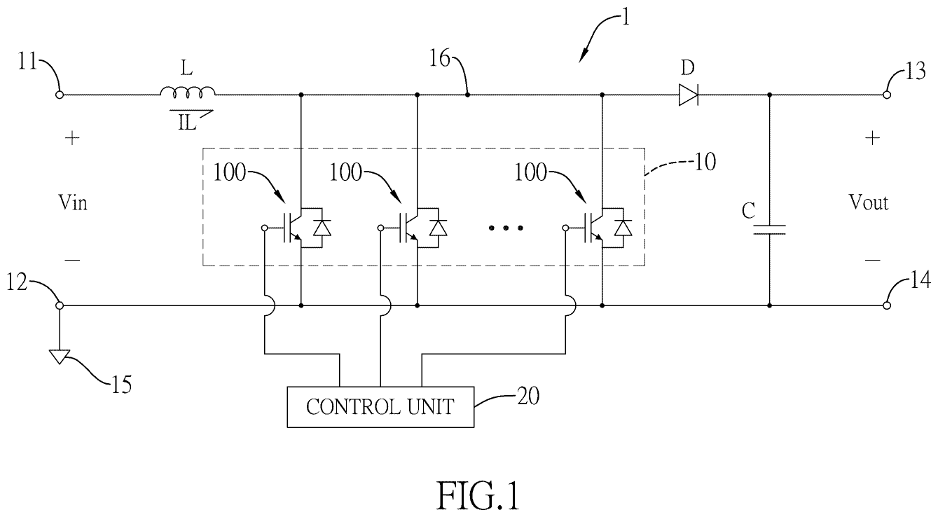

With reference to FIG. 1, the direct current to direct current (DC-DC) converter with parallel switches of the present invention comprises a switching DC-DC conversion circuit 1 and a control unit 20.

The switching DC-DC conversion circuit 1 is a switch mode power supply (SMPS) and comprises at least one switch unit 10. Each switch unit 10 comprises N switches 100 connected in parallel, wherein N is a number of the switches 100 of the switch unit 10, and N is a positive integer higher than or equal to 2. Based on the respective switching operations for the N switches 100 of the at least one switch unit 10, a DC input power Vin will be converted to a required DC output power Vout to implement the power conversion function. For example, the switching DC-DC conversion circuit 1 may be an isolated conversion circuit or a non-isolated conversion circuit with the circuit topology of Bridge converter, Boost converter, Buck converter, Buck-Boost bidirectional converter, Flyback converter, and so on.

The circuit topology of the switching DC-DC conversion circuit 1 shown in FIG. 1 is a non-isolated Boost converter just as an example. The switching DC-DC conversion circuit 1 of the present invention is not limited to the example. The circuit topology of the switching DC-DC conversion circuit 1 of FIG. 1 comprises a switch unit 10, an inductor L, a diode D, and a capacitor C. The switch unit 10 comprises N switches 100 connected in parallel. Input side of the switching DC-DC conversion circuit 1 comprises a first input terminal 11 and a second input terminal 12. Output side of the switching DC-DC conversion circuit 1 comprises a first output terminal 13 and a second output terminal 14. The second input terminal 12 and the second output terminal 14 are electrically connected to a reference voltage terminal 15 (such as a ground). A terminal of the inductor L is electrically connected to the first input terminal 11. Another terminal of the inductor L is electrically connected to the anode of the diode D. There is a node 16 between the inductor L and the anode of the diode D. The cathode of the diode D and a terminal of the capacitor C are electrically connected to the first output terminal 13. Another terminal of the capacitor C is electrically connected to the reference voltage terminal 15. Each one of the switches 100 comprises a first connection terminal, a second connection terminal, and a control terminal. The first connection terminal is electrically connected to the node 16. The second connection terminal is electrically connected to the reference voltage terminal 15. The foregoing term “connected in parallel” for the switches 100 describes that the first connection terminals of the N switches 100 are electrically connected to each other (to the node 16), and the second connection terminals of the N switches 100 are electrically connected to each other (to the reference voltage terminal 15). Each one of the switches 100 is a transistor, such as an insulated gate bipolar transistor (IGBT), a metal-oxide-semiconductor field-effect transistor (MOSFET), or a bipolar junction transistor (BJT). The switch 100 shown in FIG. 1 is IGBT as an example, such that the collector of the IGBT is the first connection terminal, the emitter of the IGBT is the second connection terminal, and the gate is the control terminal.

The control unit 20 is electrically connected to the N switches 100 of the switch unit 10 to respectively turn on or off the N switches 100 of the switch unit 10. So, the control unit 20 could control each one of the N switches 100 of the switch unit 10 to be in turn-on state (ON) or turn-off state (OFF) respectively. For example, the control unit 20 may be a driver chip comprising N output terminals electrically and respectively connected to the control terminals of the N switches 100 of the switch unit 10. Or, the control unit 20 may comprise multiple driver chips to be electrically connected to the control terminals of the N switches 100 of the switch unit 10.

In an embodiment, the control unit 20 outputs N driving signals to the control terminals of the N switches 100 of the switch unit 10 respectively. The N driving signals are pulse-width modulation (PWM) signals with the same period and the same pulse width. It is understandable that each period of the PWM signal comprises an ON-time segment and an OFF-time segment. For example, the voltage level of the ON-time segment in the PWM signal may be a high level to form a pulse, and the voltage level of the OFF-time segment may be a low level. The switch 100 is operated in the turn-on state during the ON-time segment, and operated in the turn-off state during the OFF-time segment. The ON-time segments of the PWM signals for the N switches 100 do not overlap with one another. In an embodiment, the duty cycle of each of the PWM signals is lower than (1/N)×100%.

In aspect of phase, the phase of each period of the PWM signal is 0 to 360 degrees. The foregoing ON-time segment corresponds to a conduction phase. The control unit 20 may modulate the occurrence (i.e. pulse position) and the time length (i.e. pulse width) of the ON-time segment of the PWM signal, and adjust the duty cycle of the PWM signal to be lower than (1/N)×100% as mentioned above, to achieve that the conduction phases of the N driving signals are alternate with each other. Hence, at a same time, only one switch 100 of the N switches 100 is operated in the turn-on state, and the rest is operated in the turn-off state. Any two switches 100 would not be simultaneously operated in the turn-on state.

In the present invention, the N switches 100 comprise an i^{th} switch and an (i+1)^{th} switch, wherein i is a positive integer from 1 to N−1. The control method of the present invention comprises outputting an i^{th} driving signal by the control unit 20 to the i^{th} switch; and outputting an (i+1)^{th} driving signal by the control unit 20 to the (i+1)^{th} switch. The conduction phases of the i^{th} driving signal and the (i+1)^{th} driving signal are alternate with each other. In an embodiment, a phase difference between the conduction phases of the i^{th} driving signal and the (i+1)^{th} driving signal is 360/N degrees. Pulse phase control, such as phase shift or phase delay, performed by the control unit 20 for the PWM signals is common knowledge in the related arts.

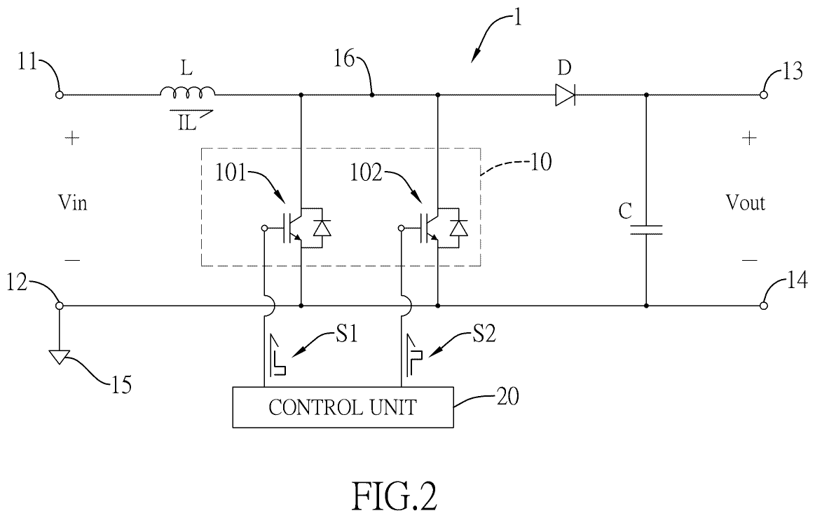

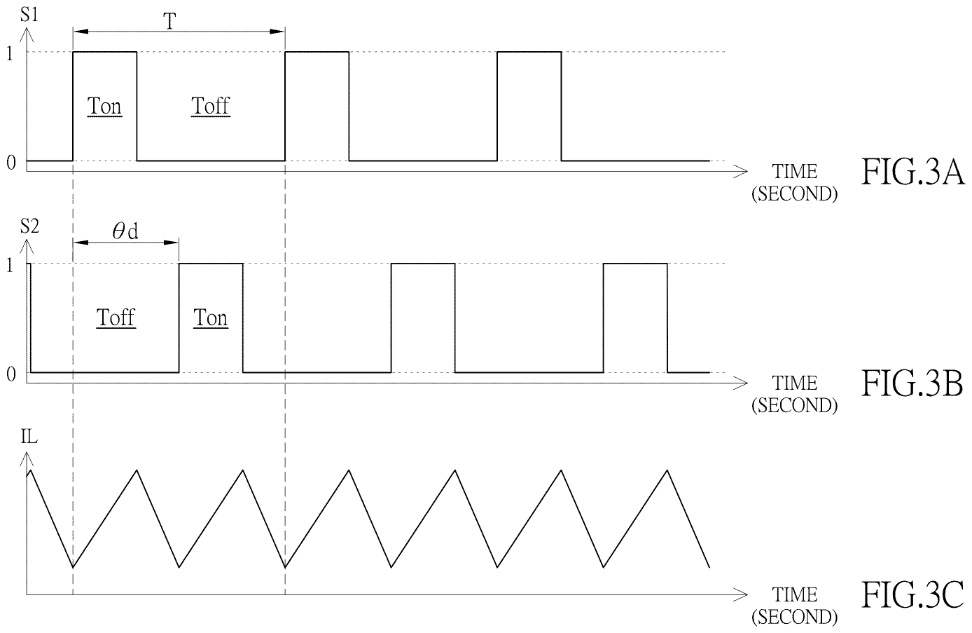

With reference to the embodiment shown in FIG. 2, the N switches 100 of the switch unit 10 are two switches 100 (N=2). The two switches 100 are defined as a first switch 101 and a second switch 102. With reference to FIGS. 3A and 3B, the control unit 20 outputs a first driving signal S1 and a second driving signal S2 to the control terminals of the first switch 101 and the second switch 102 respectively. The first driving signal S1 and the second driving signal S2 are PWM signals. The duty cycles of the first driving signal S1 and the second driving signal S2 are lower than 50% (i.e. (1/N)×100%=(1/2)×100%=50%). The conduction phases of the first driving signal S1 and the second driving signal S2 are alternate with each other. The conduction phases of the first driving signal S1 and the second driving signal S2 differ from each other by 180 degrees. Namely, the phase difference θd between the first driving signal S1 and the second driving signal S2 as shown in FIG. 3B is 180 degrees (i.e. 360°/N=360°/2=180°). The current flowing through the inductor L is defined as an inductor current IL. The waveform diagram of the inductor current IL is shown in FIG. 3. The magnitude of the inductor current IL gradually increases with the ON-time segments Ton of the first driving signal S1 and the second driving signal S2, and gradually decreases with the OFF-time segments Toff of the first driving signal S1 and the second driving signal S2. Hence, the operation frequency of the inductor L (i.e. the frequency of the inductor current IL) is N×ƒ. Because N=2 as mentioned above, N×ƒ is equal to 2ƒ. The term “T” shown in FIGS. 3A-3C is the period of the first driving signal S1 and the second driving signal S2, such that the foregoing frequency “ƒ” is equal to 1/T (i.e. ƒ=1/T).

In the present invention, because the conduction phases of the i^{th} driving signal and the (i+1)^{th} driving signal are alternate with each other, the N switches 100 of each switch unit 10 are turned on alternately. By doing so, the current will flow through the N switches 100 alternately to achieve an effect of automatic even current sharing, to improve the utilization of the N switches 100 of each switch unit 10, and to equalize the heat of the N switches 100 of each switch unit 10.

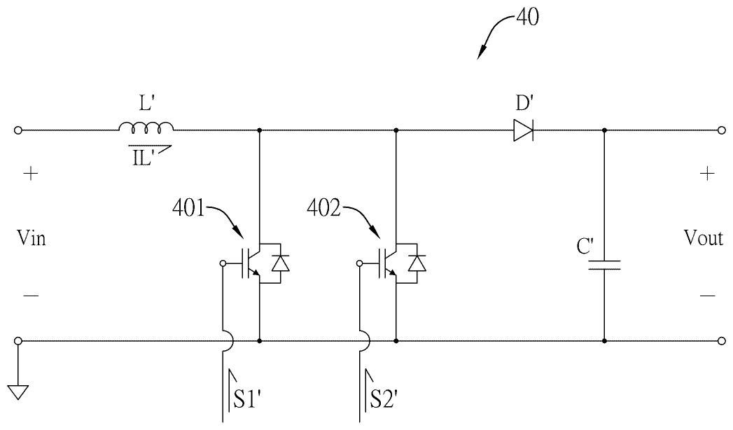

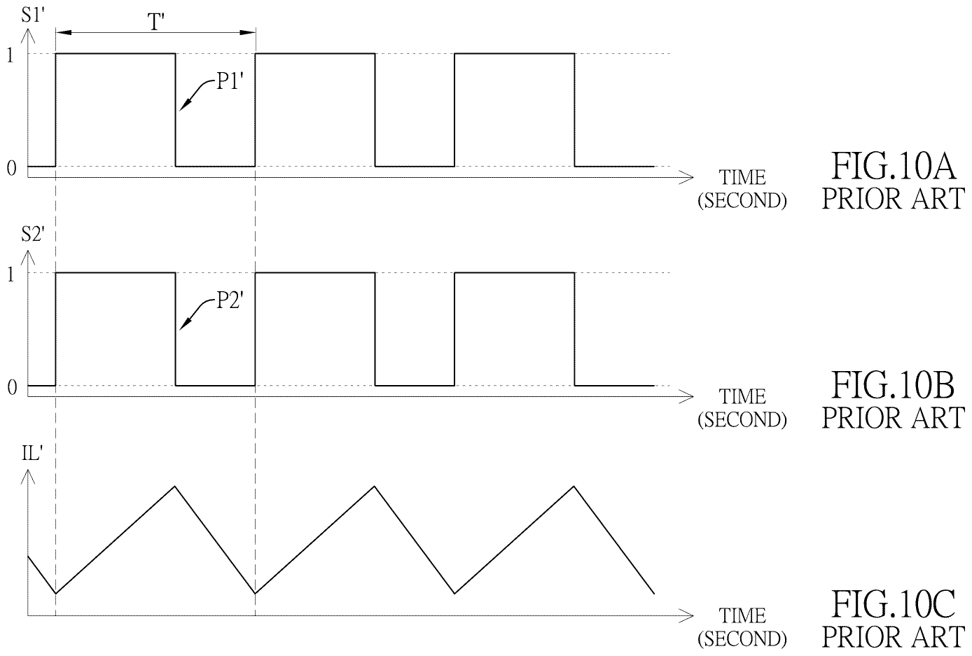

In comparison of the operation frequency of the inductor L of the present invention shown in FIG. 3C and the operation frequency of the inductor L′ of the prior art shown in FIG. 10C, the operation frequency of the inductor L of the present invention is 2ƒ, and the operation frequency of the inductor L′ of the prior art is only ƒ, such that the control method of the present invention can increase the operation frequency of the inductor L. Besides, according to the formula of inductive reactance: XL=2πƒL, wherein XL is the inductive reactance, ƒ is the operation frequency of the inductor, and L is the inductance of the inductor. When the inductive reactance XL is a constant value (i.e. the ripples of the inductor currents IL and IL′ shown in FIG. 2 and FIG. 9 are the same), the operation frequency ƒ of the inductor has a negative correlation with the inductance L of the inductor.

So, according to the control method of the present invention, the inductance of the inductor L would be decreased due to an increase of the operation frequency of the inductor L, such that the volume, the weight, the cost, and the loss of the inductor L could be further reduced, and the power conversion efficiency and the power density of the DC-DC converter of the present invention could be further improved.

Other embodiments for N>2 as well as the effects are deducible from the foregoing embodiment. For example, when N is equal to 3 (i.e. N=3), there would be three switches defined as a first switch, a second switch, and a third switch. The control unit 20 outputs a first driving signal, a second driving signal, and a third driving signal to the first switch, the second switch, and the third switch respectively. The conduction phases of the first driving signal, the second driving signal, and the third driving signal are alternate with one other. The duty cycles of the first driving signal, the second driving signal, and the third driving signal are lower than (1/3)×100%. The conduction phases of the first driving signal and the second driving signal differ from each other by 120 degrees. The conduction phases of the second driving signal and the third driving signal differ from each other by 120 degrees. So, the operation frequency of the inductor L is 3ƒ.

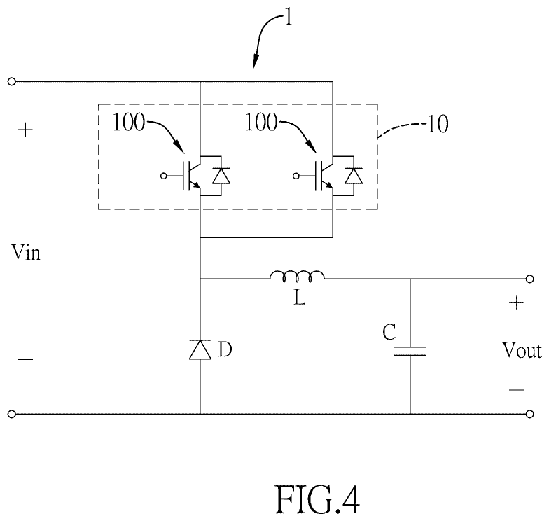

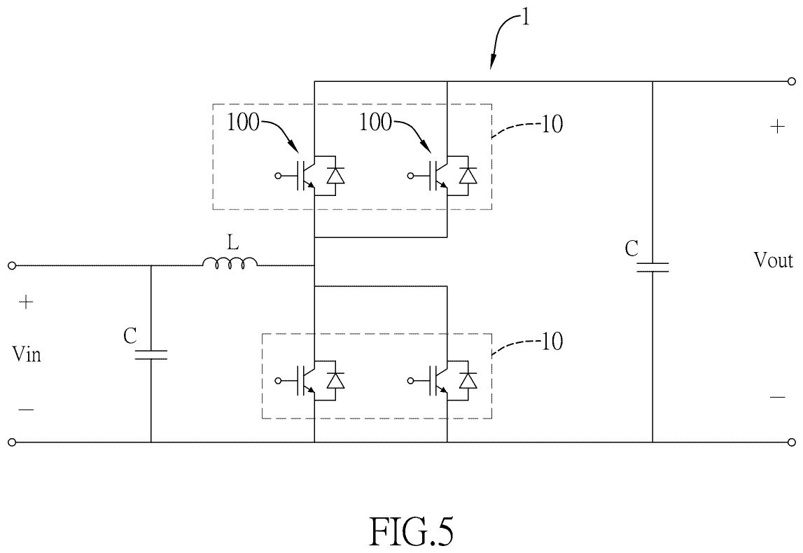

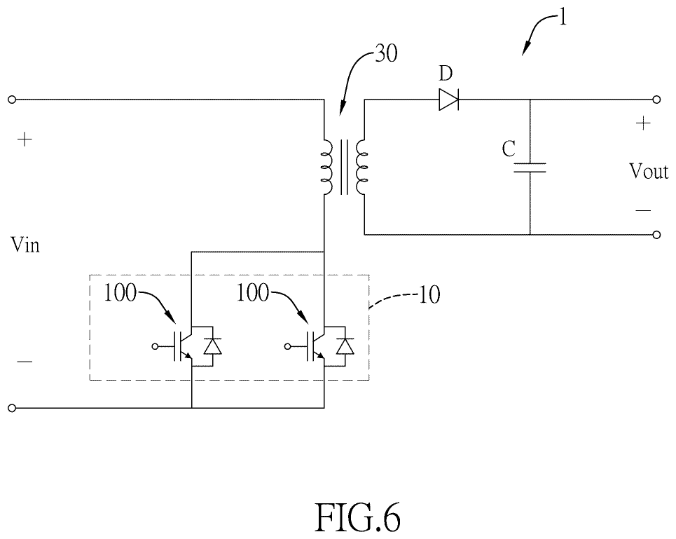

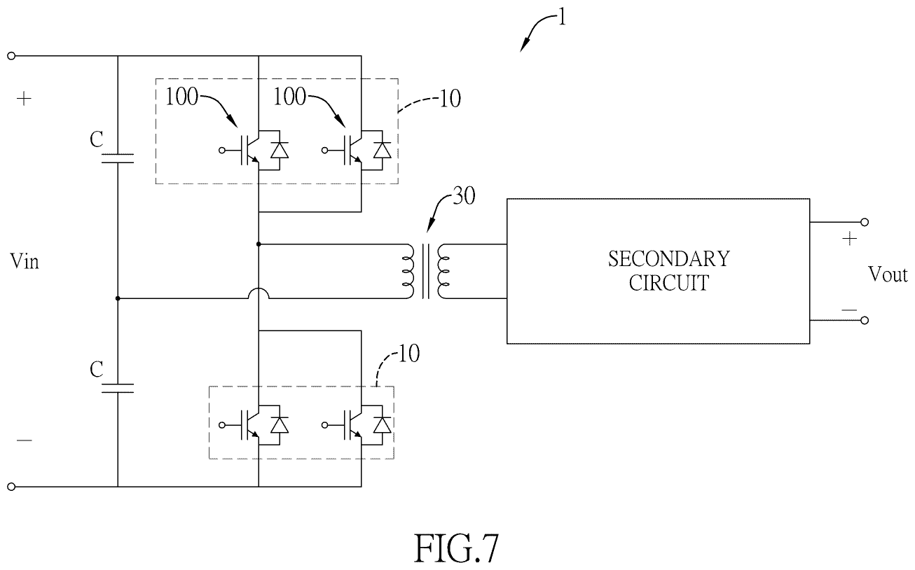

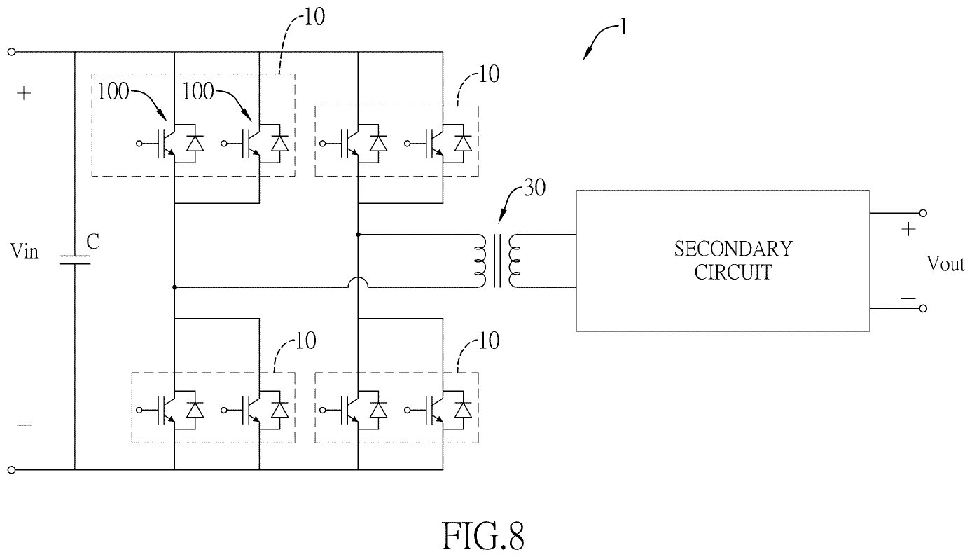

The control method of the present invention is also applicable to other isolated or non-isolated conversion circuit having the foregoing switch unit 10. For example, the switching DC-DC conversion circuit 1 shown in FIG. 4 is a non-isolated conversion circuit with the circuit topology of Buck converter having one switch unit 10; the switching DC-DC conversion circuit 1 shown in FIG. 5 is a non-isolated conversion circuit with the circuit topology of Buck-Boost bidirectional converter having two switch units 10; the switching DC-DC conversion circuit 1 shown in FIG. 6 is an isolated conversion circuit with the circuit topology of Flyback converter having one switch unit 10; the switching DC-DC conversion circuit 1 shown in FIG. 7 is an isolated conversion circuit with the circuit topology of Half-Bridge converter having multiple switch units 10 respectively connected to the bridge arms; and the switching DC-DC conversion circuit 1 shown in FIG. 8 is an isolated conversion circuit with the circuit topology of Full-Bridge converter having multiple switch units 10 respectively connected to the bridge arms. Their technical effects can be deduced from the foregoing example of the non-isolated Boost converter. So, the volume and the weight of the transformer 30 shown in FIGS. 6-8 and the inductor L shown in FIGS. 4 and 5 could be reduced. Correspondingly, the cost of the transformer 30 or the inductor L could be reduced. The loss by the transformer 30 or the inductor L could be reduced. The power conversion efficiency and the power density of the DC-DC converter of the present invention could be further improved due to the reduction of the loss by the transformer or the inductor.

What is claimed is:

1. A direct current to direct current (DC-DC) converter with parallel switches, comprising:
a switching DC-DC conversion circuit comprising at least one switch unit each comprising N switches connected in parallel, wherein the N switches comprise an i^{th} switch and an (i+1)^{th} switch, N is a positive integer higher than or equal to 2, and i is a positive integer from 1 to N−1; and
a control unit electrically connected to the N switches of the at least one switch unit to respectively turn on or off the N switches of the at least one switch unit; wherein the control unit outputs an i^{th} driving signal and an (i+1)^{th} driving signal to the i^{th} switch and the (i+1)^{th} switch respectively, and conduction phases of the i^{th} driving signal and the (i+1)^{th} driving signal are alternate with each other.

2. The DC-DC converter as claimed in claim 1, wherein a phase difference between the conduction phases of the i^{th} driving signal and the (i+1)^{th} driving signal is 360/N degrees.

3. The DC-DC converter as claimed in claim 1, wherein the i^{th} driving signal and the (i+1)^{th} driving signal are pulse-width modulation signals having duty cycles lower than (1/N)×100% respectively.

4. The DC-DC converter as claimed in claim 2, wherein the i^{th} driving signal and the (i+1)^{th} driving signal are pulse-width modulation signals having duty cycles lower than (1/N)×100% respectively.

5. A control method of a DC-DC converter with parallel switches, performed in a control unit, wherein the control unit is electrically connected to at least one switch unit each comprising N switches connected in parallel of a switching DC-DC conversion circuit, the N switches comprise an i^{th} switch and an (i+1)^{th} switch, N is a positive integer higher than or equal to 2, and i is a positive integer from 1 to N−1, and the control method comprising:
outputting an i^{th} driving signal to the i^{th} switch; and
outputting an (i+1)^{th} driving signal to the (i+1)^{th} switch, wherein conduction phases of the i^{th} driving signal and the (i+1)^{th} driving signal are alternate with each other.

6. The control method as claimed in claim 5, wherein a phase difference between the conduction phases of the i^{th} driving signal and the (i+1)^{th} driving signal is 360/N degrees.

7. The control method as claimed in claim 5, wherein the i^{th} driving signal and the (i+1)^{th} driving signal are pulse-width modulation signals having duty cycles lower than (1/N)×100% respectively.

8. The control method as claimed in claim 6, wherein the i^{th} driving signal and the (i+1)^{th} driving signal are pulse-width modulation signals having duty cycles lower than (1/N)×100% respectively.
